(19) United States
(12) Patent Application Publication
(10) Pub. No.: US 2012/0163864 A1
(43) Pub. Date: Jun. 28, 2012

(54) IMAGE FORMING APPARATUS

(75) Inventors: Junichi Tanimoto, Toyokawa-shi (JP); Naoki Nonoyama, Toyokawa-shi (JP)

(73) Assignee: Konica Minolta Business Technologies, Inc., Tokyo (JP)

(21) Appl. No.: 13/325,490

(22) Filed: Dec. 14, 2011

(30) Foreign Application Priority Data
Dec. 22, 2010 (JP) 2010-285528

(51) Int. Cl. G03G 15/20

(52) U.S. Cl. 399/122

(57) ABSTRACT

An image forming apparatus includes an image processor, an exterior housing, a fixing unit, an outlet, and a first partition. The image processor is configured to transfer a toner image to a recording medium. The exterior housing accommodates the image processor. The fixing unit is configured to fix the toner image, transferred by the image processor to the recording medium, onto the recording medium. The outlet is on the exterior housing and communicates with a conveyance path extending from the image processor toward the fixing unit. The first partition is adjacent the outlet on the exterior housing. The first partition separates the image processor and the fixing unit from one another.

### CROSS-REFERENCE TO RELATED APPLICATIONS

The present application claims priority under 35 U.S.C. §119 to Japanese Patent Application No. 2010-285528, filed Dec. 22, 2010. The contents of this application are accommodated herein by reference in their entirety.

### BACKGROUND OF THE INVENTION

1. Field of the Invention

The present invention relates to an image forming apparatus.

2. Discussion of the Background

In electrographic image forming apparatuses, it is widespread practice to pass a recording medium loaded with an unfixed toner image through a fixing nip portion defined between a heating roller heated by a heat source and a pressure roller contacting the heating roller, where the recording medium is heated and pressed and thereby the unfixed toner is fixed on the recording medium. In this respect, the image forming apparatuses each include a fixing unit of heat roller type.

Japanese Unexamined Patent Application Publication No. 2003-202765 and Japanese Unexamined Patent Application Publication No. 2008-164905 disclose a fixing unit disposed at an interior corner of an apparatus and an outlet adjacent the fixing unit. A cooling fan discharges the air around the fixing unit through the outlet to keep the internal temperature from rising. Japanese Unexamined Patent Application Publication No. 1993-088515 discloses a heat insulation space or a heat insulation material between an image processor and a fixing unit.

### SUMMARY OF THE INVENTION

According to one aspect of the present invention, an image forming apparatus includes an image processor, an exterior housing, a fixing unit, an outlet, and a first partition. The image processor is configured to transfer a toner image to a recording medium. The exterior housing accommodates the image processor. The fixing unit is configured to fix the toner image, transferred by the image processor to the recording medium, onto the recording medium. The outlet is on the exterior housing and communicates with a conveyance path extending from the image processor toward the fixing unit. The first partition is adjacent the outlet on the exterior housing. The first partition separates the image processor and the fixing unit from one another.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic front view of an MFP according to a first embodiment;

FIG. 2 is a perspective view of the MFP;

FIG. 3 is a schematic front view of the MFP with a fixing housing removed;

FIG. 4 is a horizontal sectional view of the fixing housing;

FIG. 5A is a partially enlarged front view of the MFP illustrating a secondary transfer roller in contact with an intermediate transfer roller, and 5B is a partially enlarged front view of the MFP illustrating the secondary transfer roller out of contact with the intermediate transfer roller; and

FIG. 6 is a schematic view of an MFP according to a second embodiment.

### DESCRIPTION OF THE EMBODIMENTS

The embodiments will now be described with reference to the accompanying drawings, wherein like reference numerals designate corresponding or identical elements throughout the various drawings.

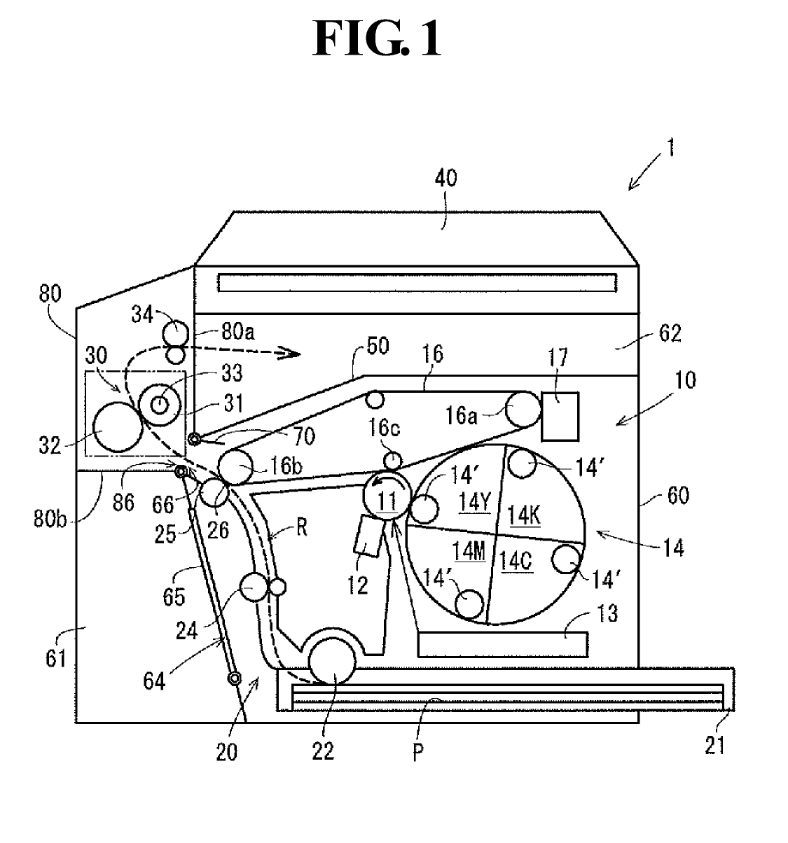

In the embodiments, a multi-functional printer 1 (hereinafter referred to as an MFP) will be described as an exemplary image forming apparatus. In the following description, terms (for example, “left and right” and “upper and lower”) indicating specific directions and positions are used where necessary. In this respect, the direction perpendicular to the paper plane of FIG. 1 is defined as front view. The terms are used for the sake of description and will not limit the technical scope of the present invention.

First, an overview of the MFP 1 will be described by referring to FIG. 1. The MFP 1 shown in FIG. 1 has multiple functions including a copying function, a scanning function, a printing function, and a facsimile function, and is capable of data communications through networks such as a LAN and a phone line. Specifically, the MFP 1 is capable of outputting image data read from a document model to another computer through a network, or inputting image data from another computer through a network and printing the image data, or transmitting and receiving FAX data.

The MFP 1 includes an image processor 10, a feeder 20, a fixing unit 30, and an image reader 40. The image processor 10 forms a toner image by known electrophotography. The feeder 20 supplies and transmits a recording medium P to a transfer position 26 of the image processor 10. The fixing unit 30 fixes the toner image that the image processor 10 has transferred to the recording medium P. The image reader 40 is disposed above the image processor 10. Specifically, the image processor 10 forms a toner image based on image data obtained at the image reader 40 or based on image data received from an external terminal or other device through a network (for example, LAN). The image processor 10 then transfers the toner image to a recording medium P conveyed by the feeder 20. The feeder 20 conveys the recording medium P loaded with the toner image to the fixing unit 30. The toner image is fixed onto the recording medium P at the fixing unit 30. The MFP 1 is of what is called the in-body output type, in which the recess between the image reader 40 and the image processor 10 is used as a collection tray 50. Thus, the recording medium P loaded with the fixed toner image is output onto the collection tray 50 between the image reader 40 and the image processor 10.

The image processor 10 includes a drum photoreceptor 11, which is an exemplary image carrier, and transfers a toner image on the photoreceptor 11 to the recording medium P. Around the photoreceptor 11, a charger 12, a developing unit 14, an intermediate transfer belt 16, and a photoreceptor cleaner 15 are arranged in this order in the anti-clockwise direction as seen in FIG. 1. An image exposing unit 13 is disposed below the intermediate transfer belt 16. The image exposing unit 13 carries out image exposure against the photoreceptor 11 through the space between the charger 12 and the developing unit 14. A sheet feed cassette 21, which is a component of the feeder 20, is disposed below the image exposing unit 13. The photoreceptor 11 is drivingly rotated in the anti-clockwise direction as seen in FIG. 1 by a photoreceptor driving motor (not shown). The charger 12 is applied a photoreceptor charging voltage from an output-variable charging power source (not shown) at predetermined timings.

The developing unit 14 is in the form of a rack that includes four developers, namely, a black developer 14K, a cyan developer 14C, a magenta developer 14M, and a yellow developer 14Y. The developing unit 14 is drivingly rotated in the clockwise direction as seen in FIG. 1 by a rack driver (not shown) that includes a stepping motor. The developing unit 14 includes the black developer 14K, the cyan developer 14C, the magenta developer 14M, and the yellow developer 14Y in this order in the clockwise direction as seen in FIG. 1 at equal 90-degree intervals.

The developers 14K, 14C, 14M, and 14Y include exchangeable toner cartridges (not shown) of corresponding colors. Specifically, the black developer 14K includes a black toner cartridge, the cyan developer 14C includes a cyan toner cartridge, the magenta developer 14M includes a magenta toner cartridge, and the yellow developer 14Y includes a yellow toner cartridge. The developers 14K, 14C, 14M, and 14Y each include a developing roller 14′ to develop an electrostatic latent image on the photoreceptor 11. In addition to the developing roller 14′, the developers 14K, 14C, 14M, and 14Y each include a toner supply roller to supply toner to the developing roller 14′, a toner regulating blade to regulate the thickness of the toner on the developing roller 14′, and other elements.

The developers 14K, 14C, 14M, and 14Y use negatively charged toner to reverse develop an electrostatic latent image on the photoreceptor 11. The developing unit 14 is rotated to move the developers 14K, 14C, 14M, and 14Y to a development position on the photoreceptor 11, where the electrostatic latent image is reverse developed. The developing roller 14′, at the surface of the photoreceptor 11 (that is, at the development position), is applied a development bias from an output-variable development bias power supply (not shown). The developing roller 14′ at the development position is drivingly rotatable in the clockwise direction as seen in FIG. 1 by the development roller driving motor (not shown). In this state, from a power source (not shown), a toner supply bias is applicable to the toner supply roller and a controlling bias is applicable to the toner regulating blade.

The intermediate transfer belt 16 is looped around a group of rollers including a drive roller 16a, a driven roller 16b across from the drive roller 16a, and a primary transfer roller 16c disposed in opposition to the photoreceptor 11. The primary transfer roller 16c is applied a primary transfer voltage from a primary transfer power source (not shown). The drive roller 16a is drivingly rotated in the clockwise direction as seen in FIG. 1 by a transfer belt driving motor (not shown) so as to drivingly rotate the intermediate transfer belt 16 in the clockwise direction as seen in FIG. 1.

A secondary transfer roller 25 is disposed on the outer side of a portion of the intermediate transfer belt 16 wound around the driven roller 16b. The secondary transfer roller 25 moves into and away from contact with the intermediate transfer belt 16 at predetermined timings. The intermediate transfer belt 16 and the secondary transfer roller 25 define, at the portion of their contact, the transfer position 26. The secondary transfer roller 25 is applied a secondary transfer voltage from a secondary transfer power source (not shown). A belt cleaner 17 to remove toner or other substance remaining after the secondary transfer is disposed on the outer side of a portion of the intermediate transfer belt 16 wound around the drive roller 16a.

The feeder 20 includes the sheet feed cassette 21, a sheet feed roller 22, a pair of resist rollers 24, and the secondary transfer roller 25. The sheet feed cassette 21 accommodate the recording media P. The sheet feed roller 22 picks up the recording media P in the sheet feed cassette 21 one at a time starting from the uppermost piece. The pair of resist rollers 24 convey the recording medium P to the transfer position 26 of the image processor 10 at predetermined timings. The recording media P in the sheet feed cassette 21 are sent to the conveyance path R one at a time starting from the uppermost piece by the rotation of the sheet feed roller 22. The conveyance path R serves as a path through which the recording medium P is subjected to the printing steps. The sheet feed roller 22 is drivingly rotated by a sheet feed motor (not shown), and the pair of resist rollers 24 are drivingly rotated by a resist motor (not shown).

The fixing unit 30, which fixes unfixed toner on the recording medium P, is disposed above the secondary transfer roller 25 (that is, further downstream than the secondary transfer roller 25 in the conveyance direction). The fixing unit 30 includes a fixing roller 31 and a pressure roller 32. The fixing roller 31 incorporates a fixing heater 33 such as a halogen lamp. The pressure roller 32 is opposite the fixing roller 31. The fixing roller 31 and the pressure roller 32 define, at the portion of their contact, a fixing position. A controller (not shown) in the apparatus controls power to the fixing heater 33 to keep the fixing heater 33 at a temperature necessary for the fixing. A pair of discharge rollers 34 are disposed further downstream than the fixing position of the fixing unit 30 in the conveyance direction. The printed recording medium P is discharged on the collection tray 50 by rotational driving of the pair of discharge rollers 34.

Thus, the MFP 1 forms a toner image on a recording medium P using at least one of the four developers 14K, 14C, 14M, and 14Y based on a command from the controller (not shown) disposed in the apparatus. An example of formation of a full color image using the four developers 14K, 14C, 14M, and 14Y will be described below.

First, the rack driver rotates the developing unit 14 to move the yellow developer 14Y to the development position, thereby bringing the development roller 14′ of the yellow developer 14Y into contact with the photoreceptor 11. Accordingly, the photoreceptor 11 is rotated in the anti-clockwise direction as seen in FIG. 1, and the intermediate transfer belt 16 is also rotated. At this stage of the process, the secondary transfer roller 25 is kept out of contact with the intermediate transfer belt 16. Then, the charger 12, which is applied a photoreceptor charging voltage from the charging power source, uniformly charges the surface of the rotating photoreceptor 11 to a predetermined potential. The charged region of the photoreceptor 11 is subjected to image exposure dedicated to a yellow image by the image exposing unit 13, thus forming a yellow electrostatic latent image. The yellow electrostatic latent image is developed by the developer 14Y to form a yellow toner image. The yellow toner image is primary transferred to the intermediate transfer belt 16 by the primary transfer roller 16c, which is applied a primary transfer voltage.

Then, similarly to the formation of the yellow toner image, the magenta developer 14M is moved to the development position, and a magenta toner image on the photoreceptor 11 is transferred to the intermediate transfer belt 16. Likewise, the cyan developer 14C is moved to the development position, and a cyan toner image on the photoreceptor 11 is transferred to the intermediate transfer belt 16. Likewise, the black developer 14K is moved to the development position, and a black toner image on the photoreceptor 11 is transferred to the intermediate transfer belt 16. The color toner images are formed on the photoreceptor 11 and primary transferred to the intermediate transfer belt 16 at timings when the color toner images are superimposed one on top of each other on the intermediate transfer belt 16.

Meanwhile, the sheet feed roller 22 picks up a recording medium P from the sheet feed cassette 21 and conveys the recording medium P to the conveyance path R toward the pair of resist rollers 24. When the forwarding edge of the recording medium P is detected by a timing sensor (not shown) disposed on the outlet side of the pair of resist rollers 24, the pair of resist rollers 24 are stopped to turn the recording medium P into standby state at the detected position. The secondary transfer roller 25 is brought into contact with the intermediate transfer belt 16 prior to the combined toner image on the intermediate transfer belt 16 reaches the secondary transfer roller 25 by the rotation of the intermediate transfer belt 16. The recording medium P is conveyed to the transfer position 26 by the pair of resist rollers 24 at the timing when the combined toner image reaches the transfer region 26. Thus, the combined toner image is secondary transferred to the recording medium P.

The recording medium P loaded with the combined toner image is subjected to fixing of the combined toner image at the fixing unit 30, and then is discharged on the collection tray 50 through between the pair of discharge rollers 34. The obtained recording medium P is loaded with a full-color image. The toner and other substance remaining on the photoreceptor 11 after the primary transfer are removed by the photoreceptor cleaner 15, while the toner and other substance remaining on the intermediate transfer belt 16 after the secondary transfer are removed by the belt cleaner 17.

Next, a first embodiment of a mounting structure of the fixing unit 30 will be described by referring to FIG. 1 to FIG. 5. In the first embodiment, the MFP 1 includes an exterior housing 60 and a fixing housing 80. The exterior housing 60 is approximately in the form of a box with its interior hollowed out to accommodate the image processor 10. The fixing housing 80 is approximately in the form of a box with its interior hollowed out to accommodate the fixing unit 30. The exterior housing 60 and the fixing housing 80 are formed as separate entities. In the first embodiment, the exterior housing 60 includes a pair of front and rear legs 61 on the left side surface. The legs 61 have upper portions that protrude beyond the upper surface of the exterior housing 60 (collection tray 50). A read supporter 62 stands on a rear portion of the upper surface of the exterior housing 60. The image reader 40 is supported by the upper ends of the legs 61 and by the upper end of the read supporter 62.

The image reader 40 according to the first embodiment is mounted on the exterior housing 60 with at least a part of the image reader 40 overlapping a mounting height H, which the fixing housing 80 has when mounted on the exterior housing 60. In this embodiment, the image reader 40 is supported by the upper ends of the legs 61 and by the upper end of the read supporter 62 with approximately half of the image reader 40 overlapping the mounting height H, which the fixing housing 80 has when mounted on the exterior housing 60.

Each of the legs 61 has a hollow structure to accommodate a part of the main frame of the MFP 1, which is not elaborated in the drawings. This ensures stabilization of the gravity center and support rigidity in the MFP 1, thereby contributing to the structure of disposing the image reader 40 on the upper portion of the MFP 1. It is also possible to accommodate various parts of the MFP 1 in the legs 61.

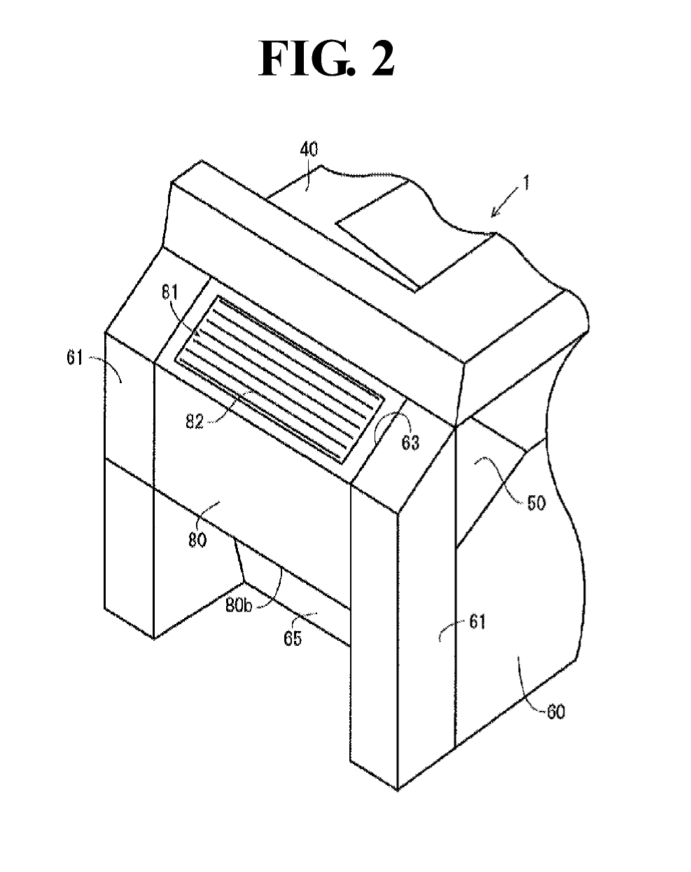

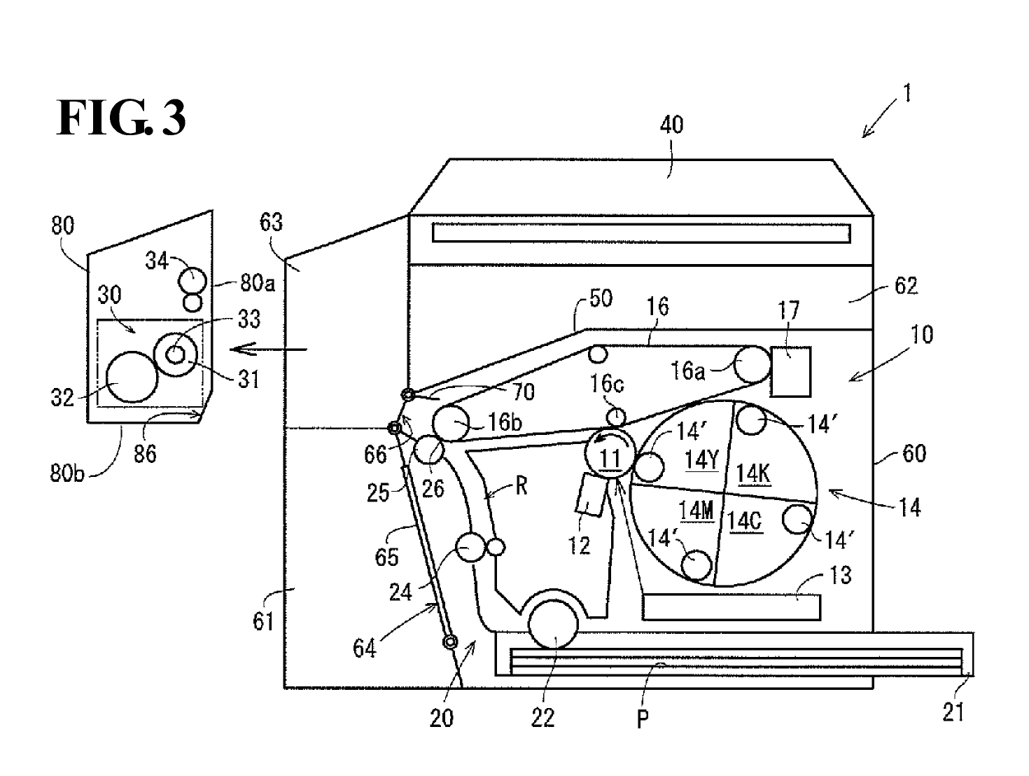

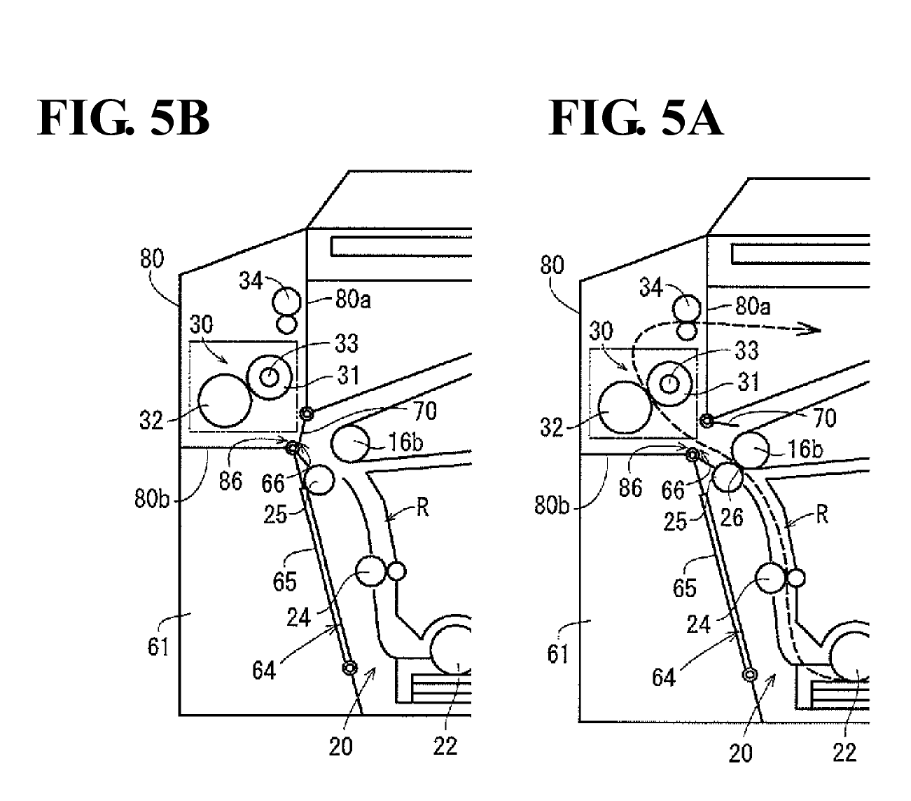

As shown in FIG. 2 and FIG. 3, the space between the upper portions of the legs 61 serves as a mounting portion 63 with which the fixing housing 80 is fitted. The fixing housing 80 is removably mounted on the mounting portion 63 between the legs 61 of the exterior housing 60, and protrudes toward the left outer side (in the lateral direction) beyond the image reader 40. As shown in FIG. 1 and FIG. 3, an opening 64 through which the image processor 10 is exposed is disposed between the legs 61 on the left side surface of the exterior housing 60. Usually, the opening 64 is openably closed by a cover 65, which is vertically pivotable about its lower end. For example, when a paper jam occurs, the user opens the cover 65 and puts a hand in through the opening 64 to perform necessary operations (for example, pull out the recording medium P). As shown in FIG. 1 and FIG. 5, the fixing housing 80 mounted on the mounting portion 63 of the exterior housing 60 is disposed above the transfer position 26 of the image processor 10. On the top surface of the fixing housing 80, a vent 81 is disposed to provide communication between the interior and exterior of the fixing housing 80. The vent 81 includes a louver 82 to adjust the amount of ventilation and other quantities.

The exterior housing 60 includes an outlet 66 at the upper left corner of the exterior housing 60. The outlet 66 communicates with the conveyance path R extending from the image processor 10 to the fixing unit 30. The outlet 66 is an approximately rectangular opening with longer sides in the front and rear direction (sheet width direction of the recording medium P), so as to permit the recording medium P to pass through the opening, and with shorter sides in a direction orthogonal to the conveyance path R (thickness direction of the recording medium P), so as to minimize the opening area. The fixing housing 80 includes an inlet 86 at the lower right corner of the fixing housing 80. The inlet 86 communicates with the conveyance path R extending from the image processor 10 to the fixing unit 30. The inlet 86 is also an approximately rectangular opening with longer sides in the front and rear direction (sheet width direction of the recording medium P), so as to permit the recording medium P to pass through the opening, and with shorter sides in a direction orthogonal to the conveyance path R, so as to minimize the opening area.

When the fixing housing 80 is mounted on the mounting portion 63 of the exterior housing 60, the outlet 66 and the inlet 86 come into contact with one another, thereby establishing communication therebetween. This makes the conveyance path R run from the image processor 10 to the fixing unit 30. In this state, the fixing housing 80 is exposed (to ambient air) on the upper, left, and right surfaces. When the fixing housing 80 is mounted on the mounting portion 63 of the exterior housing 60, the image processor 10 and the fixing unit 30 are separated from one another by partitions adjacent the outlet 66 of the exterior housing 60 (on the upper and left surfaces) and by partitions adjacent the inlet 86 of the fixing housing 80 (on the right and lower surfaces). In the first embodiment, a recess is provided between the upper surface of the exterior housing 60 (collection tray 50) and the right surface 80a of the fixing housing 80. An opening and closing space between the legs 61 is provided on the left side surface (cover 65) of the exterior housing 60 and under a bottom surface 80b of the fixing housing 80.

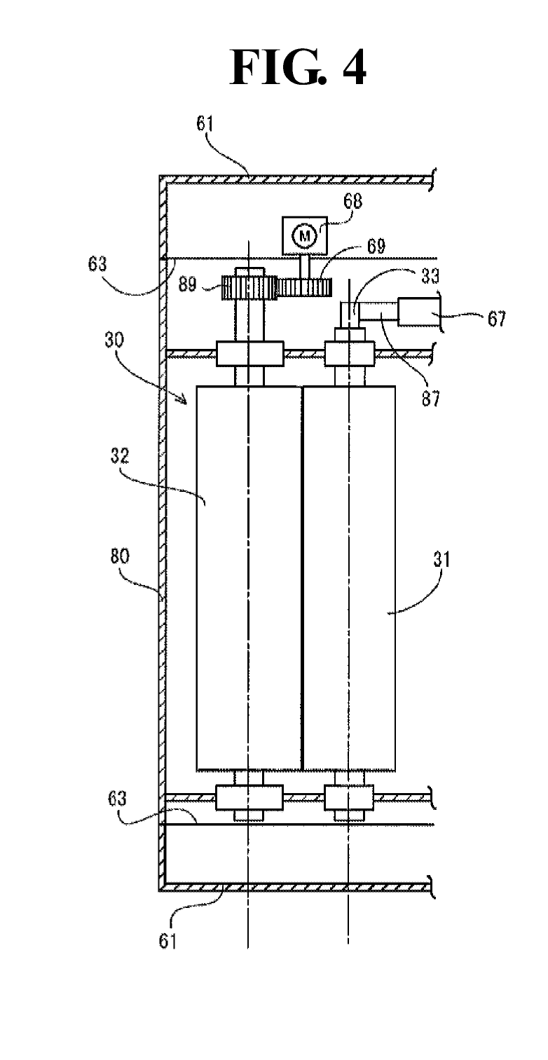

As shown in FIG. 1, FIG. 3, and FIG. 5, the fixing housing 80 accommodates the fixing roller 31 and the pressure roller 32, which constitute the fixing unit 30, and the pair of discharge rollers 34. The fixing roller 31 and the pressure roller 32 are in pressure contact with one another and extend in the sheet width direction to be rotatably supported on front and rear plates of the fixing housing 80 (see FIG. 4). The pair of discharge rollers 34 extend in parallel to the fixing roller 31 and the pressure roller 32 to be rotatably supported on the front and rear plates of the fixing housing 80, which is not elaborated in the drawings.

As shown in FIG. 4, the fixing roller 31 includes the fixing heater 33 (for example, a halogen heater) as a heat source. The fixing heater 33 extends in the sheet width direction. On one end side of the fixing heater 33, a fixing connector 87 is disposed. The fixing connector 87 is electrically coupled to a main body connector 67 through which power is supplied. The main body connector 67 is disposed in one of the legs 61 of the exterior housing 60. The main body connector 67 and the fixing connector 87 are coupled to and decoupled from one another in conjunction with the fixing housing 80 attached to and detached from the exterior housing 60. Specifically, the main body connector 67 and the fixing connector 87 are oriented to ensure such a positional relationship that when the fixing housing 80 is mounted on the mounting portion 63 of the exterior housing 60, the main body connector 67 and the fixing connector 87 are fitted with another to establish electrical coupling therebetween, while when the fixing housing 80 is removed from the mounting portion 63, the fixing connector 87 is decoupled from the main body connector 67 to cut the electrical coupling. The heat source of the fixing roller 31 is not limited to the halogen heater. Other possible examples include, but not limited to, an IH heater and a resistance heating element. It is also possible to use a heat source utilizing ultrasonic wave.

One of the legs 61 of the exterior housing 60 accommodates a fixing drive roller 68 as a driving source to generate rotary force. The fixing drive roller 68 is power transmittably coupled to any one of the fixing roller 31 and the pressure roller 32 through a drive transmission member 36 such as a gear. In the first embodiment, the pressure roller 32 is drivingly rotated by the fixing driving motor 68, and the fixing roller 31 is rotated by the frictional force resulting from the pressure contact with the pressure roller 32. The driving and driven relationship may be the other way round. In the case of the pressure roller 32 on the driving side, the fixing drive roller 68 transmits power to a motor gear 69, which meshes with a pressure driving gear 89 secured to the roller shaft of the pressure roller 32. The drive transmission member 36 is a combination of the motor gear 69 and the pressure driving gear 89.

The drive transmission member 36 turns into meshed state in conjunction with mounting of the fixing housing 80 on the exterior housing 60. This is similar to the relationship between the main body connector 67 and the fixing connector 87. Specifically, the motor gear 69 and the pressure driving gear 89 are set to ensure such a positional relationship that when the fixing housing 80 is mounted on the mounting portion 63 of the exterior housing 60, the motor gear 69 and the pressure driving gear 89 mesh with one another to turn into power transmittable state, while when the fixing housing 80 is removed from the mounting portion 63, the meshing between the motor gear 69 and the pressure driving gear 89 is released to cut power transmission.

As shown in FIG. 5A and FIG. 5B, the outlet 66 of the exterior housing 60 is openably closed by an openable cover 70, which is an opening and closing member vertically pivotable about its upper end. The openable cover 70 is opened when the recording medium P is conveyed from the image processor 10 to the fixing unit 30. The openable cover 70 according to the first embodiment is opened and closed in conjunction with the secondary transfer roller 25 moving into and away from contact with the intermediate transfer belt 16. Specifically, the openable cover 70 is opened at the time of contact of the secondary transfer roller 25 with the intermediate transfer belt 16, thereby permitting the recording medium P to pass through the conveyance path R extending from the image processor 10 to the fixing unit 30 (see FIG. 5A). The openable cover 70 is closed at the time of detachment of the secondary transfer roller 25 from the intermediate transfer belt 16 and is kept in closed state (see FIG. 5B).

Thus, the exterior housing 60 includes the outlet 66 to communicate with the conveyance path R extending from the image processor 10 to the fixing unit 30. The image processor 10 and the fixing unit 30 are separated from one another by the partitions adjacent the outlet 66 (on the upper and left surfaces) of the exterior housing 60. In other words, the image processor 10 and the fixing unit 30 communicate with one another only through the outlet 66, and otherwise are delimited by the partitions of the exterior housing 60. Since the exterior housing 60 is in contact with (exposed to) ambient air, even when the heat from the fixing unit 30 travels to the exterior housing 60, the exterior housing 60 is readily cooled by ambient air. This makes the heat from the fixing unit 30 difficult to reach the image processor 10 in the exterior housing 60. In other words, the amount of heat from the fixing unit 30 to the image processor 10 decreases. This minimizes the influence that the heat from the fixing unit 30 has on the image processor 10 without the conventional practice to provide a cooling fan for the fixing unit 30 or provide a heat insulation space or a heat insulation material.

Since the fixing unit 30 is accommodated in (surrounded by) the fixing housing 80, the temperature of the fixing unit 30 is more readily controlled than in the conventional art. This, as an additional advantage, minimizes waste of power and ensures efficient utilization of power. The fixing housing 80 includes the inlet 86 to communicate with the conveyance path R. The image processor 10 and the fixing unit 30 are separated from one another by partitions 50 and 65 adjacent the outlet 66 of the exterior housing 60 and by partitions 80a and 80b adjacent the inlet 86 of the fixing housing 80. This limits the travel of the heat from the fixing unit 30 to the image processor 10 only through the outlet 66 and the inlet 86 communicating with the conveyance path R. Accordingly, the amount of heat from the fixing unit 30 to the image processor 10 further decreases. Even if the heat in the fixing unit 30 becomes excessively high, the heat is released through the partitions adjacent the inlet 86 of the fixing housing 80. This results in an additional, highly advantageous effect in maintaining the temperature of the fixing unit 30.

In the first embodiment, the fixing housing 80 is mounted on the exterior housing 60 at a position above the transfer position 26 of the image processor 10. This is where the “hot air moves upward” rule applies, and effectively minimizes the influence that the heat from the fixing unit 30 has on the image processor 10 disposed below the fixing unit 30. Additionally, the exterior housing 60 and the fixing housing 80 communicate with one another through the outlet 66 and the inlet 86, which communicate with the conveyance path R. This ensures that even when the air in the exterior housing 60 is heated through driving of the image processor 10 or other operations, the heated air readily flows into the fixing housing 80 due to an ascending air current resulting from a thermal gradient (what is called a chimney effect). This minimizes an increase in temperature in the exterior housing 60 (image processor 10).

The fixing housing 80 is removably mounted on the exterior housing 60, that is, the fixing housing 80 and the exterior housing 60 are formed as separate entities. This ensures that the heat from the fixing unit 30 is blocked by the exterior housing 60 and within the fixing housing 80. Additionally, the fixing housing 80 includes the vent 81 on the upper surface to provide communication between the interior and exterior of the fixing housing 80. This ensures that excessively high heat in the fixing unit 30 is efficiently discharged outside through the vent 81 by the chimney effect. Further, the fixing housing 80 protrudes beyond the exterior housing 60 in the lateral direction. This prevents vertical alignment of the fixing unit 30 in the fixing housing 80 and the image processor 10 in the exterior housing 60. This also contributes to minimization of heat transmission from the fixing unit 30 to the image processor 10.

The exterior housing 60 according to the first embodiment includes the openable cover 70 to openably close the outlet 66. The openable cover 70 is opened when the recording medium P is conveyed from the image processor 10 to the fixing unit 30. That is, the openable cover 70 is kept closed when there is no need to open the outlet 66 and the inlet 86 to establish communication with the conveyance path R. This contributes to minimization of heat transmission from the fixing unit 30 to the image processor 10.

The image reader 40 according to the first embodiment is mounted on the exterior housing 60 with at least a part of the image reader 40 overlapping the mounting height H, which the fixing housing 80 has when mounted on the exterior housing 60. This makes the fixing housing 80 and the image reader 40 laterally aligned with one another. This minimizes the possibility of the image reader 40 adversely affected by the heat from the fixing unit 30, which in turn reduces variations in the accuracy of image reading.

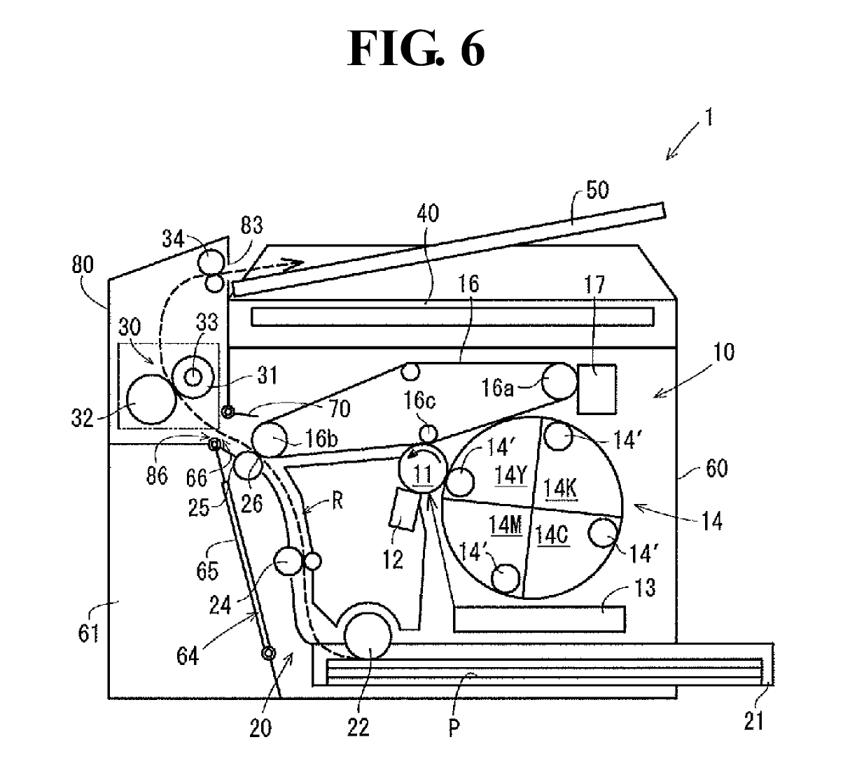

Next, a second embodiment of the mounting structure of the fixing unit 30 will be described by referring to FIG. 6. In the second embodiment, no recess is provided between the image reader 40 and the upper surface of the exterior housing 60. At an upper portion of the right side surface of the fixing housing 80, a sheet outlet 83 is disposed to face the pair of discharge rollers 34. The sheet outlet 83 is disposed above the image reader 40. The collection tray 50 is disposed over the image reader 40. The image reader 40 according to the second embodiment is mounted on the fixing housing 60 with at least a part of the image reader 40 overlapping the mounting height H, which the fixing housing 80 has when mounted on the exterior housing 60. Specifically, the image reader 40 is mounted on the top surface of the fixing housing 60 and thoroughly overlaps the mounting height H, which the fixing housing 80 has when mounted on the exterior housing 60. The second embodiment is otherwise similar to the first embodiment.

This configuration makes the fixing housing 80 and the image reader 40 laterally aligned with one another, similarly to the first embodiment. This minimizes the possibility of the image reader 40 adversely affected by the heat from the fixing unit 30, which in turn reduces variations in the accuracy of image reading. Additionally, the image reader 40 according to the second embodiment is mounted on the upper surface of the exterior housing 60. This shortens the entire height of the MFP 1 and lowers the center of gravity. This, as a result, lowers the position of the image reader 40 and minimizes the influence that oscillations have throughout the MFP 1. Further, the sheet outlet 83, through which the recording medium P is discharged, is disposed above the image reader 40. This prevents heat carried by a printed recording medium P from being transferred to the image processor 10. Further, the printed recording medium P is discharged on a portion above the image reader 40. This ensures that heat carried by the printed recording medium P is readily released outside, thereby minimizing the influence of the heat on the image reader 40.

Thus, in the embodiments, the exterior housing accommodating the image processor includes the outlet to communicate with the conveyance path extending from the image processor to the fixing unit. The image processor and the fixing unit are separated from one another by the partitions adjacent the outlet of the exterior housing. In other words, the image processor and the fixing unit communicate with one another only through the outlet, and otherwise are delimited by the partitions of the exterior housing. Since the exterior housing is in contact with (exposed to) ambient air, even when the heat from the fixing unit travels to the exterior housing, the exterior housing is readily cooled by ambient air. This makes the heat from the fixing unit difficult to reach the image processor in the exterior housing. In other words, the amount of heat from the fixing unit to the image processor decreases. This minimizes the influence that the heat from the fixing unit has on the image processor without the conventional practice to provide a cooling fan for the fixing unit or provide a heat insulation space or a heat insulation material.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus comprising:
an image processor configured to transfer a toner image to a recording medium;
an exterior housing accommodating the image processor;
a fixing unit configured to fix the toner image, transferred by the image processor to the recording medium, onto the recording medium;
an outlet on the exterior housing, the outlet communicating with a conveyance path extending from the image processor toward the fixing unit; and
a first partition adjacent the outlet on the exterior housing, the first partition separating the image processor and the fixing unit from one another.

2. The image forming apparatus according to claim 1, further comprising:
a fixing housing accommodating the fixing unit; and
an inlet on the fixing housing, the inlet communicating with the conveyance path; and
a second partition adjacent the inlet on the fixing housing, the second partition together with the first partition separating the image processor and the fixing unit from one another.

3. The image forming apparatus according to claim 2, wherein the fixing housing is mounted on the exterior housing at a position above a transfer position of the image processor.

4. The image forming apparatus according to claim 2, wherein the fixing housing is removably mounted on the exterior housing.

5. The image forming apparatus according to claim 2, further comprising a vent on a top surface of the fixing housing, the vent being configured to provide communication
between an interior and an exterior of the fixing housing.

6. The image forming apparatus according to claim 2, wherein the image forming apparatus has a lateral direction, and the fixing housing protrudes beyond the exterior housing in the lateral direction.

7. The image forming apparatus according to claim 6, further comprising:
a pair of legs on the exterior housing, the pair of legs supporting the fixing housing; and
a cover between the legs on the exterior housing, the cover openably closing an opening through which the image processor is exposed.

8. The image forming apparatus according to claim 2, further comprising an opening and closing member on the exterior housing, the opening and closing member openably closing the outlet, the opening and closing member being configured to open the outlet when the recording medium is conveyed from the image processor to the fixing unit.

9. The image forming apparatus according to claim 8, further comprising a transfer roller configured to move into and away from contact with an image carrier disposed in the image processor,
wherein the opening and closing member is configured to open and close the outlet in conjunction with the transfer roller moving into and away from contact with an image carrier.

10. The image forming apparatus according to claim 2, further comprising an image reader configured to read an image on a document model,
wherein the fixing housing mounted on the exterior housing has a mounting height, and the image reader is mounted on the exterior housing with at least a part of the image reader overlapping the mounting height.

11. The image forming apparatus according to claim 10, further comprising a discharge opening above the image reader, the recording medium being discharged through the discharge opening.
